(19) United States
(12) Patent Application Publication
(10) Pub. No.: US 2026/0080010 A1
(43) Pub. Date: Mar. 19, 2026

(54) ARTIFICIALLY INTELLIGENT, CONTEXT-BASED DATA PROCESSING TOOL

(71) Applicant: INTERNATIONAL BUSINESS MACHINES CORPORATION, Armonk, NY (US)

(72) Inventors: Parul SHARMA, Jaipur (IN); Akshat MATHUR, Ajmer (IN); Shwetha GOPALAKRISHNA, Bangalore (IN); Srini BHAGAVAN, Dublin, CA (US)

(21) Appl. No.: 18/884,273

(22) Filed: Sep. 13, 2024

(51) Int. Cl. G06F 16/683; G06F 16/65

(52) U.S. Cl. CPC G06F 16/685; G06F 16/65

(57) ABSTRACT

A context-based data processing tool is provided to facilitate data processing within a computing environment, where executing the context-based data processing tool includes capturing, by at least one processor set, selected content data from an electronic media, and generating, via artificial intelligence, relevant context metadata for the captured content data, and associating the generated context metadata with the captured content data. Further, executing the data processing tool includes integrating, by the at least one processor set, the captured content data into a context-based data store using the generated context metadata, where the generated context metadata facilitates processing of the captured content data within the computing environment.

### BACKGROUND

One or more aspects relate, in general, to facilitating processing within a computing environment, and in particular, to facilitating capturing of content data and processing of captured content data within the computing environment.

As the sources of unstructured data become more complex and diverse, the ability to capture and search this data for specific information becomes more challenging. Certain data formats have inherent limitations when searched utilizing standard approaches and therefore are not considered search friendly. Examples of formats that can be difficult to search include audio, audiovisual, and video data. For instance, the parameters to search video can be difficult to articulate and once articulated, the results can be difficult to find. For example, a user hoping to locate a specific image in a video archive may have to engage in manual searching to locate the image, and as the size of archives increase, this task can continue to prove more difficult and/or inefficient.

### SUMMARY

Certain shortcomings of the prior art are overcome, and additional advantages are provided herein through the provision of a computer-implemented method which includes executing a context-based data processing tool to facilitate data processing within a computing environment, where executing the context-based data processing tool includes capturing, by at least one processor set, selected content data from an electronic media and generating, via artificial intelligence, relevant context metadata for the captured content data and associating the generated context metadata with the captured content data. In addition, executing the context-based data processing tool includes integrating, by the at least one processor set, the captured content data into a context-based data store using the generated context metadata, where the generated context metadata facilitates processing of the captured content data within the computing environment.

Computer program products and computer systems relating to one or more aspects are also described and claimed herein. Further, services relating to one or more aspects are also described and may be claimed herein.

Additional features and advantages are realized through the techniques described herein. Other embodiments and aspects are described in detail herein and are considered a part of the claimed aspects.

### BRIEF DESCRIPTION OF THE DRAWINGS

One or more aspects are particularly pointed out and distinctly claimed as examples in the claims at the conclusion of the specification. The foregoing and objects, features, and advantages of one or more aspects are apparent from the following detailed description taken in conjunction with the accompanying drawings in which:

FIG. 1 depicts one example of a computing environment to include and/or use one or more aspects of the present disclosure;

FIG. 2A depicts another example of a computing environment to include and/or use one or more aspects of the present disclosure;

FIG. 2B depicts one embodiment of a computer program product with a context-based data processing tool, in accordance with one or more aspects of the present disclosure;

FIG. 3 depicts one embodiment of a context-based data processing tool workflow, in accordance with one or more aspects of the present disclosure; and

FIG. 4 depicts a further embodiment of a context-based data processing tool workflow, in accordance with one or more aspects of the present disclosure.

### DETAILED DESCRIPTION

Aspects of the present disclosure and certain features, advantages, and details thereof, are explained more fully below with reference to the non-limiting example(s) illustrated in the accompanying drawings. Descriptions of well-known software, systems, devices, processing techniques, etc., are omitted so as not to unnecessarily obscure the disclosure in detail. It should be understood, however, that the detailed description and the specific example(s), while indicating aspects of the disclosure, are given by way of illustration only, and are not by way of limitation. Various substitutions, modifications, additions, and/or arrangements, within the spirit and/or scope of the underlying inventive concepts will be apparent to those skilled in the art for this disclosure. Note further that reference is made below to the drawings, where the same or similar reference numbers used throughout different figures designate the same or similar components. Also, note that numerous inventive aspects and features are disclosed herein, and unless otherwise inconsistent, each disclosed aspect or feature is combinable with any other disclosed aspect or feature as desired for a particular application of the concepts disclosed.

Note also that illustrative embodiments are described below using specific code, designs, architectures, protocols, layouts, schematics, systems, or tools only as examples, and not by way of limitation. Furthermore, the illustrative embodiments are described in certain instances using particular software, hardware, tools, and/or data processing environments only as example for clarity of description. The illustrative embodiments can be used in conjunction with other comparable or similarly purposed structures, systems, applications, architectures, etc. One or more aspects of an illustrative embodiment can be implemented in software, hardware, or a combination thereof.

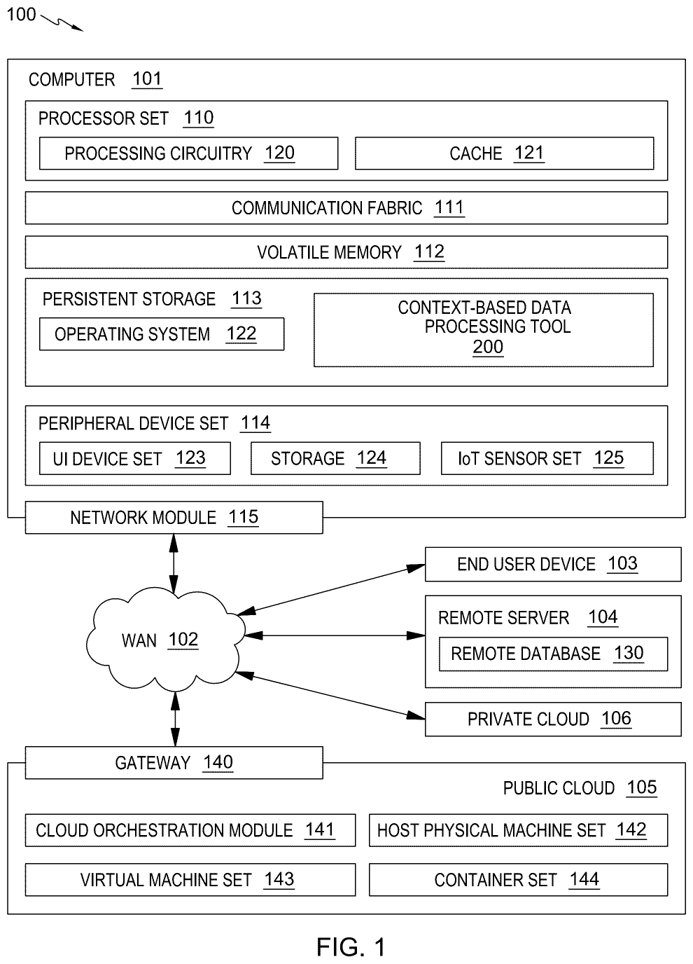

As understood by one skilled in the art, program code, as referred to in this application, can include software and/or hardware. For example, program code in certain embodiments of the present disclosure can utilize a software-based implementation of the functions described, while other embodiments can include fixed function hardware. Certain embodiments combine both types of program code. Examples of program code, also referred to as one or more programs, are depicted in FIG. 1, including operating system 122 and context-based data processing tool 200, which are stored in persistent storage 113.

In one or more aspects, capabilities are provided herein to facilitate processing within a computing environment. In one or more aspects, capabilities are provided to facilitate data processing in which unstructured data capture and accessibility is improved, and data store (e.g., memory, storage, and/or a combination of memory/storage) requirements are reduced. Processing within the computing environment is enhanced by improving the capture of selected content data, as well as processing of the captured content data, including, but not limited to, obtaining context metadata and associating the context metadata to the captured content data to, for instance, facilitate storage and/or retrieval of content data to/from a context-based data store. Advantageously, by obtaining and associating artificial intelligence (AI) produced context metadata to the captured content data, such as to selected captured content data, processing is streamlined, storage requirements are reduced, and memory access is improved. Further, the context-based data processing tool disclosed also facilitates enhancing data security within a computing environment and can be advantageous in combating deepfake audio and/or video data by associating AI-generated context metadata with the captured content data. Advantageously, the context-based data processing tool disclosed also facilitates obtaining logically correct content data in a logically correct sequence and facilitates the obtaining, storing and retrieval of valid, authenticated content data.

One or more aspects of the present disclosure are incorporated in, performed and/or used by a computing environment. As examples, the computing environment can be of various architectures and of various types, including, but not limited to: personal computing, client-server, distributed, virtual, emulated, partitioned, non-partitioned, cloud-based, quantum, grid, time-sharing, clustered, peer-to-peer, mobile, having one node or multiple nodes, having one or more processor sets, each with one processor or multiple processors, and/or any other type of environment and/or configuration, etc., that is capable of executing a process (or multiple processes) that, e.g., perform processing, such as disclosed herein. Aspects of the present disclosure are not limited to a particular architecture or environment.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

As illustrated in FIG. 1, computing environment 100 contains an example of an environment for the execution of at least some of the computer code involved in performing the inventive methods, such as context-based data processing tool or block 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

Communication fabric 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in block 200 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End User Device (EUD) 103 is any computer system that is used and controlled by an end user (for example, a customer of an enterprise that operates computer 101) and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

Cloud computing services and/or microservices (not separately shown in FIG. 1): private and public clouds 106 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to an “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

The computing environment described above is only one example of a computing environment to incorporate, perform and/or use one or more aspects of the present disclosure. Other examples are possible. Further, in one or more embodiments, one or more of the components/modules of FIG. 1 need not be included in the computing environment and/or are not used for one or more aspects of the present disclosure. Further, in one or more embodiments, additional and/or other components/modules can be used. Other variations are possible.

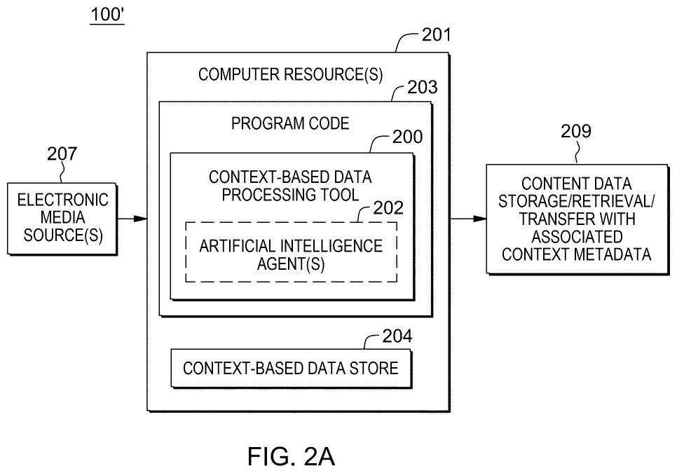

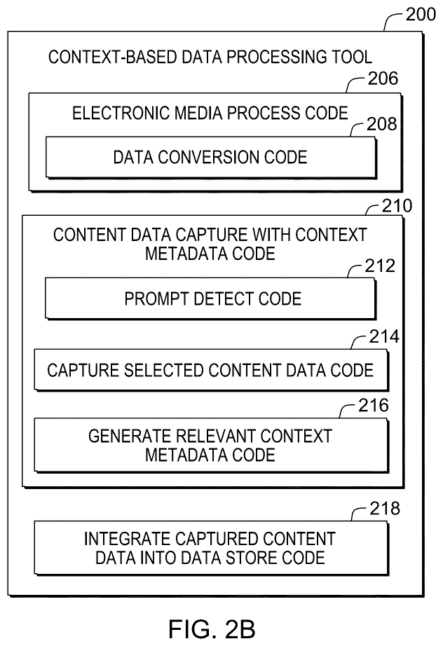

By way of further example, FIG. 2A depicts another embodiment of a computing environment 100′, which can incorporate, use or implement, one or more aspects of an embodiment of the present disclosure. In one or more embodiments, computing environment 100′ is implemented as part of, or includes, a computing environment such as computing environment 100 described above in connection with FIG. 1. Computing environment 100′ contains one or more computing resources 201, such as one or more computers 101 of FIG. 1, connected to receive (e.g., obtain, access, etc.) data or datastreams from one or more electronic media sources 207 for selectively capturing content data from the electronic media source(s) and associating generated context metadata with the captured content data to facilitate processing, such as disclosed herein. Note that, as used herein, the phrase electronic media covers any of a variety of technologies which record, save, transmit, etc. data such as a presentation, recording, podcast, show, etc. These include digital, audio, and video recordings, presentations, computing environment saved data, online content as well more conventional media including television, radio, telephone, and computing-based generated, saved and/or accessed data. Note that the electronic media can be a streaming media where a continuous datastream is generated or received for an undefined period of time, such as the case with video and/or audio security systems, as well, for instance, with certain industrial monitoring systems, production monitoring systems, etc. As used herein, the electronic media can further be, or include, any text-based media, audio-based media and/or video-based media being accessed, monitored and/or received by the context-based data processing tool disclosed herein.

In one or more embodiments, the one or more computing resources 201 execute program code 203 that implements, for instance, one or more aspects of context-based data processing tool 200, such as disclosed herein. In one or more embodiments, context-based data processing tool 200 includes, or utilizes, one or more artificial intelligence (AI) agents 202, which can be part of context-based data processing tool 200 or accessed by context-based data processing tool 200. Context-based data processing tool 200 facilitates integrating selectively captured content data, as described herein, into a context-based data store 204 using, for instance, AI-generated context metadata, where the generated context metadata facilitates storage, retrieval, transfer and/or processing of the captured content data within the computing environment.

As noted, in one or more embodiments, capabilities are provided herein to facilitate data processing in which data accessibility (including unstructured data accessibility) is improved and data store (e.g., memory, storage, and/or a combination of memory/storage) requirements are reduced. Processing within the computing environment is enhanced by improving the capture of selected content data, processing of the captured content data, including, but not limited to, obtaining context metadata and associating the context metadata to the captured content data to, for instance, facilitate storage and/or retrieval of the content data to/from a context-based data store. Advantageously, by obtaining and associating AI-generated context metadata to the captured content data, such as selected unstructured data, processing is streamlined, storage requirements are reduced, and memory access is improved. Further, the context-based data processing tool disclosed herein facilitates enhancing data security within a computing environment and can be advantageous in combating deepfake data, such as deepfake audio and/or video data, by associating generated context metadata with the data. The context-based data processing tool disclosed also facilitates obtaining logically correct content data in a logically correct sequence, and further facilitates the obtaining, storing and retrieval of valid, authenticated content data. In one or more embodiments, context-based data processing tool 200 provides the AI-generated relevant context metadata for the captured content data as part of one or more content data storage/retrieval/transfer operations 209 to facilitate, for instance, data processing with improved data accessibility, contextualization, security, as well as improved storage, retrieval, and transfer, etc.

In one or more implementations, computing environment 100′ can include, or utilize, one or more networks for interfacing various aspects of computing resource(s) 201, as well as one of or more other components, systems, etc., receiving a content data storage/retrieval/transfer action 209 of the context-based data processing tool 200 in a manner that facilitates processing of data within the computing environment. By way of example, the network(s) can be, for instance, a telecommunications network, a local area network (LAN), a wide area network (WAN), such as the Internet, or a combination thereof, and can include wired, wireless, fiber optic connections, etc. The network(s) can include one or more wired and/or wireless networks that are capable of receiving and transmitting data, including training data for one or more machine learning models of the context-based data processing tool, and an output solution, recommendation, action of the machine learning context-based data processing tool, such discussed herein.

In one or more implementations, computing resource(s) 201 house and/or execute program code 203 configured to perform computer-implemented methods in accordance with one or more aspects of the present disclosure. By way of example, computing resource(s) 201 can be a computing-system-implemented resource(s). Further, for illustrative purposes only, computing resource(s) 201 in FIG. 2A is depicted as being a single computing resource. This is a non-limiting example of an implementation. In one or more other embodiments, computing resource(s) 201, which implements one or more aspects of processing such as discussed herein, can, at least in part, be implemented in multiple separate computing resources or systems, such as one or more computing resources of a cloud-hosting environment, by way of example.

Briefly described, in one embodiment, computing resource(s) 201 can include one or more processor sets with one or more processors, for instance, central processing units (CPUs). Also, the processor set(s) can include functional components used in the integration of program code, such as functional components to fetch program code from locations in memory, such as cache or main memory, decode program code, and execute program code, access memory for instruction execution, and write results of the executed instructions or code. The processor set(s) can also include a register(s) to be used by one or more of the functional components. In one or more embodiments, the computing resource(s) can include memory, input/output, a network interface, and storage, which can include and/or access, one or more other computing resources and/or databases, as required to implement the context-based data processing tool processing described herein. The components of the respective computing resource(s) can be coupled to each other via one or more buses and/or other connections. Bus connections can be one or more of any of several types of bus structures, including a memory bus or a memory controller, a peripheral bus, an accelerated graphics port, and a processor or local bus, using any of a variety of architectures. By way of example, but not limitation, such architectures can include the Industry Standard Architecture (ISA), the micro-channel architecture (MCA), the enhanced ISA (EISA), the Video Electronic Standard Association (VESA), local bus, and peripheral component interconnect (PCI). As noted, examples of a computing resource(s), or computing system(s) or competitor(s), which can implement one or more aspects disclosed are described further herein with reference to the figures.

In one or more embodiments, program code 203 includes, executes, accesses, etc., one or more artificial intelligence agents 202 which (in one or more embodiments) can train and/or use one or more machine learning models that embody (in part), or are used by, the context-based data processing tool 200. The artificial intelligence agent(s) can be existing artificial intelligence agents and/or can include, or use, one or more machine learning models that can be pretrained using training data that can include a variety of types of data or datastreams. In one or more embodiments, program code 203 executing on one or more computing resources 201 applies one or more algorithms of, for instance, the artificial intelligence agent(s) 202 to generate and train the model(s), which the program code then utilizes to, for instance, implement one or more aspects of context-based data processing tool 200. In an initialization or learning stage, program code 203 can train one or more machine learning models using obtained training data to implement, for instance, one or more aspects of the code, functions and/or modules described herein.

Data used to train the models (in one or more embodiments of the present disclosure) can include a variety of types of data, such as data generated by one or more electronic media sources for the context-based data processing process and/or data stored in one or more databases accessible by the computing resource(s). Program code, in embodiments of the present disclosure, can perform data analysis to generate data structures, including algorithms utilized by the program code to implement the context-based data processing tool and/or initiate (or perform) an action. As known, machine learning-based modeling solves problems that cannot be solved by numerical means alone. In one example, program code extracts features/attributes from the training data, which can be stored in memory or one or more databases. The extracted features can be utilized to develop a predictor function, h(x), also referred to as a hypothesis, which the program code utilizes as a model. In identifying machine learning model(s), various techniques can be used to select features (elements, patterns, attributes, etc.), including but not limited to, diffusion mapping, principal component analysis, recursive feature elimination (a brute force approach to selecting features), and/or a random forest, to select the attributes related to the particular model. Program code can utilize one or more algorithms to train the model(s) (e.g., the algorithms utilized by program code), including providing weights for conclusions, so that the program code can train any predictor or performance functions included in the model. The conclusions can be evaluated by a quality metric. By selecting a diverse set of training data, the program code trains the model to identify and weigh various attributes (e.g., features, patterns) that correlate to enhanced performance of the model.

In one or more embodiments, program code, executing on one or more processors, utilizes one or more artificial intelligence agents (now known or later developed) to facilitate implementing one or more aspects disclosed herein. In one or more embodiments, the program code can interface with application programming interfaces to perform a cognitive analysis of obtained and/or converted data. Specifically, in one or more embodiments, certain application programing interfaces include a cognitive agent (e.g., learning agent) that includes one or more programs, including, but not limited to, natural language classifiers, a retrieve-and-rank service that can surface the most relevant information, concepts/visual insights, tradeoff analytics, document conversion, and/or relationship extraction. In an embodiment, one or more programs analyze the data obtained by the program code from one or more sources utilizing one or more of a natural language classifier, retrieve-and-rank application programming interfaces, and tradeoff analytics application programing interfaces, etc.

In one or more embodiments, the program code can utilize one or more neural networks (NNs) to analyze training data and/or collected data to generate, for instance, one or more operational machine learning models. Neural networks are a programming paradigm which enable a computer to learn from observational data. This learning is referred to as deep learning, which is a set of techniques for learning in neural networks. Neural networks, including modular neural networks, are capable of pattern (e.g., state) recognition with speed, accuracy, and efficiency, in situations where datasets are mutual and expansive, including across a distributed network, including but not limited to, cloud computing systems. Modern neural networks are non-linear statistical data modeling tools. They are usually used to model complex relationships between inputs and outputs, or to identify patterns (e.g., states) in data (i.e., neural networks are non-linear statistical data modeling or decision-making tools). In general, program code utilizing neural networks can model complex relationships between inputs and outputs and identified patterns in data. Because of the speed and efficiency of neural networks, especially when parsing multiple complex datasets, neural networks and deep learning provide solutions to many problems in multi-source processing, which program code, in embodiments of the present disclosure, can utilize in implementing a context-based data processing, such as described herein.

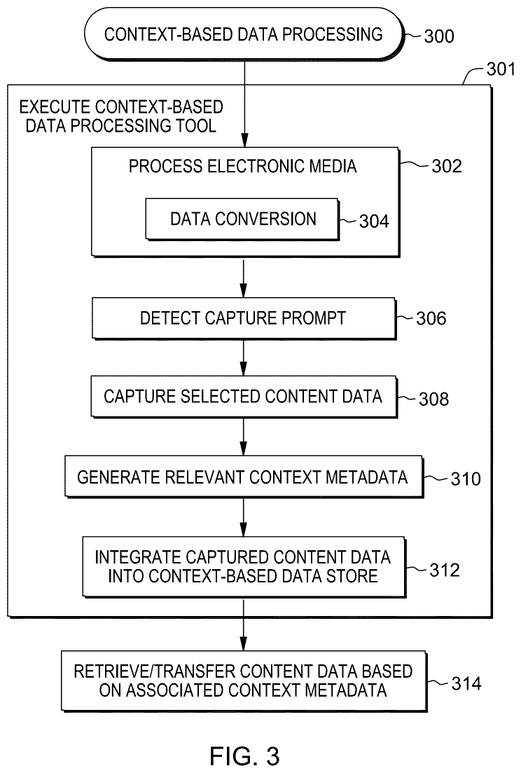

By way of example, one or more embodiments of a context-based data processing tool and workflow are described initially with reference to FIGS. 2B-3. FIG. 2B depicts one embodiment of an context-based data processing tool or module 200 that includes code or instructions to perform context-based data processing, in accordance with one or more aspects of the present disclosure, and FIG. 3 depicts one embodiment of an context-based data processing tool workflow, in accordance with one or more aspects of the present disclosure.

Referring to FIGS. 1-2B, context-based data processing tool 200 includes, in one example, various code or sub-modules used to perform processing, in accordance with one or more aspects of the present disclosure. The sub-modules are, e.g., computer-readable program code (e.g., instructions) in computer-readable media (e.g., persistent storage (e.g., persistent storage 113, such as a disk) and/or a cache (e.g., cache 121), as examples). The computer-readable media can be part of a computer program product and can be executed by and/or using one or more computers, such as computer(s) 101 and/or computer resource(s) 201; one or more processor sets 110 (FIG. 1); processors, such as one or more processors of processor set 110; and/or processing circuitry, such as processing circuitry of processor set 110, etc.

As noted, FIG. 2B depicts one embodiment of context-based data processing tool 200 which, in one or more implementations, includes, or facilitates, context-based data processing in accordance with one or more aspects of the present disclosure. In the embodiment of FIG. 2B, example code of context-based data processing tool 200 includes an electronic media process code 206 for processing an electronic media such as an audio datastream, audiovisual datastream, video datastream, etc. As illustrated, in one or more embodiments, electronic media process code 206 can include, or use, data conversion code 208 to, for instance, convert one or more aspects of a datastream to digital text data. For instance, in one or more embodiments, electronic media process code 206 converts, for example, an audio-containing datastream portion in real time to digital text data for further processing by context-based data processing tool 200. In one or more embodiments, context-based data processing tool 200 further includes a content data capture with context metadata code 210 to both capture selected content data from, for instance, electronic media and/or digital text data, and generate and associate relevant context metadata with the captured content data. In one embodiment, content data capture with context metadata code 210 includes a prompt detect code 212, which detects occurrence of a predefined prompt, with the capturing of selected content data being based on, or initiated by, detecting the occurrence of the defined prompt, such as during the converting in real time of the electronic media stream to digital text data, as described herein.

In addition, in one or more embodiments, content data capture with context metadata code 210 includes a capture selected content data code 214 for capturing selected content data obtained from one or more electronic media, such as from the digital text data obtained by converting in real time the electronic media (for example, an audio-containing datastream). As described herein, the amount of content data to be captured based on occurrence of the defined prompt can be prespecified and/or can be dynamically decided by, for instance, one or more artificial intelligence agents based on a variety of considerations including, for instance, the particular datastream from with content data is being captured, the reason for the capture of the content data, the subject matter of the content data, the subject matter of the electronic media datastream from which the data is captured, etc. For instance, depending on one more factors, the context-based data processing tool can decide to capture a summary of the current content of the media stream, a paragraph of the current content of the media stream, a sentence of the current paragraph of the media stream, a phrase or line of the current paragraph of the media stream, etc. In this manner, the type and amount of content data being captured by the context-based data processing system can vary.

In addition, in one or more embodiments, content data capture with context metadata code 210 includes a generate relevant context metadata code 216 to generate, via artificial intelligence, context metadata for the captured content data and associate the generated context metadata with the captured content data. In one or more embodiments, generating relevant context metadata can include using one or more artificial intelligence agents and/or one or more machine learning models to obtain relevant context metadata for the selected content data from the one or more electronic media, such as described herein.

In one or more embodiments, context-based data processing tool 200 further includes an integrate captured content data into data store code 218 to facilitate integrating the captured content data into a context-based data store using the generated context metadata, where the generated context metadata facilitates processing of the captured content data within the computing environment, including saving the captured content data to a context-based data store, such as to a particular context-classified record of a context-based data store, such as disclosed herein.

Note also that although various code or sub-modules are described herein, a context-based data processing tool, such as disclosed, can use, or include, additional, fewer, and/or different code/sub-modules. A particular code can include additional code, including code of other sub-modules, or less code. Further, additional and/or fewer code/sub-modules can be used. Many variations are possible.

In one or more embodiments, the context-based data processing tool is used, in accordance with one or more aspects of the present disclosure, to perform context-based data processing. FIG. 3 depicts one example of context-based data processing 300, such as disclosed herein. The process is executed, in one or more embodiments, by a computer (e.g., computer 101 (FIG. 1), computer resource(s) 201 (FIG. 2A)), and/or one or more processor sets, such as a processor or processing circuitry (e.g., of processor set 110 of FIG. 1). In one example, code or instructions implementing the process, are part of a code or module, such as context-based data processing tool 200 of FIGS. 1-2B. In other examples, the code can be included in one or more other modules and/or one or more other sub-modules of one or more other modules. Various options are available.

As illustrated in FIG. 3, in one example, context-based data processing 300 executing on one or more computers (e.g., computer 101 of FIG. 1), one or more processor sets (e.g., processor set 110 of FIG. 1, such as a processor or processing circuitry of the processor set) performs context-based data processing such as described herein, which includes, in one or more embodiments, executing a context-based data processing tool 301 to facilitate data processing within a computing environment. The context-based data processing tool can be configured such as disclosed herein. When executing the context-based data processing tool 301, computer-implemented operations are performed including processing one or more electronic media 302, including, for instance, converting one or more electronic media (or media streams) from one format into another format 304. For instance, in one embodiment, the electronic media includes unstructured data in audio format, video format, and/or audiovisual format that, in one or more aspects, is converted to digital text data.

In one or more embodiments, executing the context-based data processing tool 301 also includes detecting a capture prompt 306, which can be, for instance, detecting occurrence of an automated or manual event during executing of the tool. For instance, in one or more embodiments, the capture prompt can be an input prompt predefined for the tool, or can be user defined. The prompt can instruct the tool to automatically capture a specified amount of data adjacent to occurrence of the capture prompt. For instance, in one or more embodiments, the tool can be configured to capture a previous or subsequent phrase, sentence, paragraph, page, figure, etc. out of an electronic media stream being processed by the tool upon detection of a specific prompt. In one or more embodiments, multiple capture prompts can be predefined and/or provided by a user, with the occurrence of a respective capture prompt directing the tool to capture a different amount of a previous or subsequent phrase, sentence, paragraph, page, figure, etc. out of the electronic media stream being processed by the tool. In one or more embodiments, the context-based data processing tool can also accommodate multiple users concurrently with, for instance, different users having different authorization levels to capture content data from one or more electronic media streams. For instance, in an industrial or production environment, different users of the tool can have different responsibilities for the organization to, for instance, capture different aspects of an industrial or production process. The context-based data processing tool disclosed herein can facilitate data processing for these different users based on their responsibilities, authorizations, clearance levels, etc.

In one or more embodiments, a user can register with the context-based data processing tool for context-based data processing. To the extent implementations of the disclosure collect, store, or employ personal information provided by, or obtained from individuals (for example, a user role within an organization, user validation or authorization information, etc.), such information can be used in accordance with all applicable laws concerning protection of personal information. Additionally, the collection, storage and use of such information can be subject to consent of the individual to such activity, for example, through “opt-in” or “opt-out” processes as may be appropriate for the situation and type of information. Storage and use of personal information can be in an appropriate secure manner reflective of the type of information, for example, through various encryption and anonymization techniques for sensitive information.

Executing the context-based data processing tool 301 further includes, in one or more embodiments, capturing selected content data 308, such as capturing selected content data from an electronic media or converted data obtained from electronic media, such as from a digital text stream. As noted, in one or more embodiments, the particular content data and amount of content data being captured can be event dependent, media stream dependent, content subject matter dependent, etc., and can be statically defined or dynamically determined by the context-based data processing tool in accordance with one or more specified rules for the data capture.

Further, executing context-based data processing tool 301 includes, in one or more embodiments, generating, via artificial intelligence, relevant context metadata 310 for the captured content data. Generating relevant context data can be, for instance, via one or more artificial intelligence agents integrated with or accessed by the executing context-based data processing tool. The generated context metadata is associated with the captured content data. In one or more embodiments, the context metadata can be any of a variety of types of context data relevant to, for instance, the source, data validity, subject, etc., and or the user, a particular organization, etc. For instance, in one or more embodiments, the captured context data includes a captured phrase or sentence, and the relevant context metadata identifies or describes the electronic media stream such as source, author, speaker, publisher, location, time, date, subject matter, validity, and/or authenticity, etc. Further, in one or more embodiments, the context metadata can summarize the paragraph, page, or subject matter context within which the captured content data appeared, or was spoken, presented, described, etc. In this manner, by associating the generated context metadata with the captured content data, validity, authenticity, security, etc. of the captured content data is also documented, saved, retrieved, transferred, etc., with the data.

In addition, in one or more embodiments, the context metadata can include a subject, field, title, phrase attribute or characterization of the context of the captured content data which can then be used to integrate the captured content data into a context-based data store 312, such as disclosed herein. For instance, based on the context metadata subject, relevant content data can be saved to a common context-classified record of a data store by comparing the generated context metadata to existing context-classified records in the data store. In this way, the captured content data is automatically saved to an appropriate context-classified record to facilitate subsequent retrieval, transfer, etc. As noted, in one or more embodiments, context-based data processing can also include retrieving and/or transferring content data based on (and optionally with) the associated context metadata 314, for instance, depending on a particular computing environment request for data.

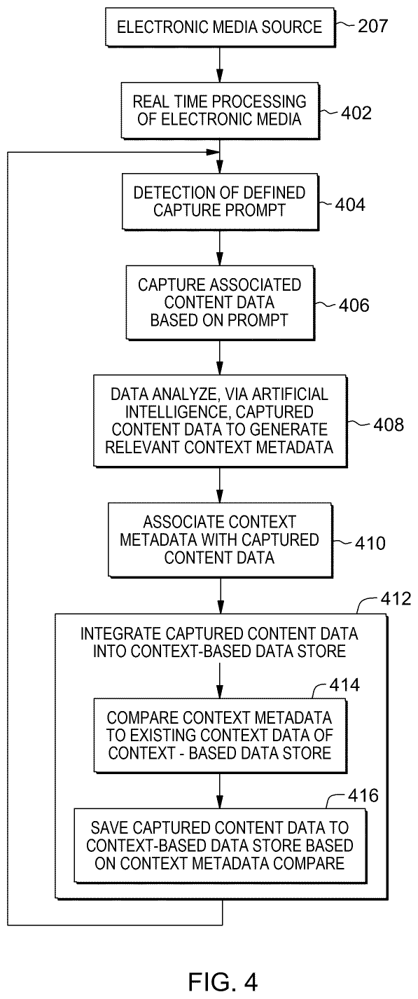

By way of further example, FIG. 4 depicts another embodiment of a context-based data processing tool workflow, in accordance with one or more aspects of the present disclosure. As disclosed herein, a context-based data processing tool and workflow are presented to facilitate efficiently capturing and organizing desired and/or relevant information from electronic media content. In many industries, production environments, as well as individual lives, a significant amount of data can be consumed from electronic media, and manually extracting and characterizing particular content from this media can be time consuming. For instance, in one or more embodiments, the context-based data processing tool disclosed herein automates a process for capturing or extracting particular lines of data content, or a particular section of data content that a user is interested in retaining, as well as characterizing (such as based on meaning), the captured content data, and seamlessly integrating the captured content data into a context-based data store, such as a personalized context-based data store system. Ultimately, productivity is enhanced, and validity and authenticity of content data is ensured, thereby facilitating processing within a computing environment, such as described herein. In one or more applications, the context-based data processing tool disclosed (when executing) drives a variety of decisions depending on the particular application(s) being used to facilitate capturing selected content data, analyzing the captured data to generate, via artificial intelligence, relevant context metadata and associating the AI-generated context metadata with the captured content data to. In this manner, the tool facilitates integrating the captured content data into a data store, such as a context-based data store, as well as, for instance, facilitates retrieval and/or transfer of the captured content data with the associated context metadata within the computing environment.

Advantageously, the context-based data processing tool and workflow disclosed herein implements intelligent decision processes to capture or apprehend content data and to select a particular application program interface (API) integrated with the tool, or system, to facilitate generating context data, such as subject or content-related data (e.g., title, field, heading, etc.) to store the captured content data into the most applicable context-based or context-classified record of a data store, whether an existing record or a new record. The analyzing of the captured data content is via one or more artificial intelligence agents, such as via cognitive analytics and generative artificial intelligence from an authorized source. In one or more embodiments, the context-based data processing tool determines whether the context under study is valid, and determines where to append or store the captured content data into an existing record or to create a new record in the data store. The disclosed tool, system, workflow drives the decision making. In one or more embodiments, the decision making can also be based on a presenter role, user role, context, etc., to generate or restructure an abstract of content data, and append the abstract with context metadata to form a realistic summary by, for instance, creating a text from an audio content, video content, and/or audiovisual content of a media stream. In one or more embodiments, the context-based data processing tool takes into account the role of a user and/or interest of a user in generating the context metadata, and in integrating the captured content data into, for instance, a context-based data store. In one or more embodiments, the context-based data processing tool incorporates or accesses a variety of available technologies including, for instance, speech recognition technology to, for instance, convert an audio-containing datastream into digital text data, natural language processing techniques to, for instance, identify one or more subjects of the captured content data, and semantics similarity models to intelligently categorize captured content data into, for instance, a context-based data store, such as into an existing context-classified record of the data store, or a new context-classified record of the data store, for instance, based on meaning or subject of the content.

As illustrated in FIG. 4, the context-based data processing tool workflow embodiment depicted includes accessing, receiving, etc., electronic media or media content from a source 207. In one embodiment, the electronic media can include audio data and/or video data which is processed in real time 402. For instance, in one or more implementations, a speech-to-text (STT) system or facility is used to translate audio content into digital text data using computational linguistics. In one or more embodiments, machine learning can also be used to facilitate, or enhance, conversion of an audio-containing datastream into digital text data for use, as described herein. A variety of speech-to-text systems or applications are available for use, depending on the desired implementation. For instance, in one or more speech-to-text systems available today can perform streaming speech recognition on a local file and/or on an audio stream to convert the audio-containing datastream into digital text data for further processing.

As illustrated, the context-based data processing further includes, in one or more implementations, detection of one or more define capture prompts 404. As discussed, the one or more capture prompts can be one or more defined prompts, such as defined content-based prompts (e.g., word based or subject matter based prompts) or one or more user input capture prompts, such as one or more input device prompts from an input device operatively coupled in the computing environment to the executing the context-based data processing tool. For instance, in one or more embodiments, processing determines whether a defined input prompt has been received from an input device, such as a key press event. For example, in one particular application, capture of a key press or a mouse press can be implemented via one or more program languages that support event-driven programming.

In one or more embodiments, the context-based data processing tool workflow includes capturing associated content data based on detection of a capture prompt 406. For instance, in one or more embodiments, the workflow can be configured to capture a previous or subsequent line of digital text data, phrase of digital text data, sentence of digital text data, paragraph of digital text data, page of digital text data, figure, etc. of the electronic media. For example, in one or more embodiments, activating a particular key or mouse button can result in the system detecting a capture prompt and automatically capturing a previous sentence or paragraph of the digital text data in real time as, for instance, a user is monitoring the electronic media. In another example, in an industrial or production environment, certain subjects or words can result in the capture of relevant content data around the words or subject to, for instance, capture desired data related to an industrial or production process.

As illustrated, in one or more embodiments, the context-based data processing tool workflow further includes data analyzing, via artificial intelligence, captured content data to generate relevant context metadata 408 and associate the generated context metadata with the captured content data 410. Context analysis can be, for instance, via one or more artificial intelligence agents integrated with or accessed by the executing content-based data processing tool. As noted, in one or more embodiments, the context metadata can be any of a variety of types of context data relevant to, for instance, the source, data validity, subject, etc. and/or the user, organization, etc. For instance, in one or more embodiments, the captured content data includes a captured phrase or sentence, and the relevant context metadata identifies or described the electronic media stream such as source, author, speaker, publisher, location, time, date, subject matter, validity and/or authenticity, etc. Further, in one or more embodiments, the context metadata can summarize the paragraph, page or subject matter context within which captured content data appeared, or was spoken, presented, described, etc. In this manner, by associating the generated context metadata with the captured content data, validity, authenticity, security, etc., of the captured content data is also documented, saved, retrieved and transferred with the data.

In one or more embodiments, the context metadata can include a subject, field, title, phrase, attribute or characterization of the context of the captured data which can be then used to integrate the captured content data into a context-based data store, such as described herein. In one or more embodiments, a natural language application program interface (API) can be used to reveal the structure and meaning of digital text data. A variety of natural language APIs are available, one or more of which also include pretrained classifications that can return a category content or label as part of the context metadata. In this manner, the context-based data processing tool workflow, in one or more embodiments, includes real time processing of electronic media, such as an audio stream, to convert the stream into digital text data, and to process the digital text data in chunks, of a size that is desired for a particular implementation. When a captured prompt is detected (e.g., a key input is detected) the previous spoken phrase, sentence, paragraph, etc. can be captured, or the subsequent phrase, sentence or paragraph can be captured, depending on the implementation. The processing parses the digital text data and identifies the selected content data for capture. Along with capturing the content data, one or more artificial intelligence agents and/or machine learning models can be used to generate relevant context metadata as desired for particular implementation that is then associated with the captured content data. Associating the captured content data with the generated context metadata can include, in one embodiment, temporality storing the content data and context metadata in a file or system clipboard for further processing, such as described herein.

In one or more embodiments, the context-based data processing tool workflow further includes integrating the captured content data into a data store, such as a context-based data store 412. For instance, in one or more embodiments, the context metadata can include a subject, field, title, phrase, attribute or characterization of the context of the captured content data, which can then be used to compare against existing context metadata of a context-based data store 414. For instance, in one embodiment, the context metadata can include a heading or title that corresponds to the heading or title of different context-classified records in the context-based data store. Based on comparing the generated context metadata to existing context metadata within the data store, the captured content data is saved to an appropriate record, such as an appropriate context-classified record, within the data store 416. Note in this regard that the appropriate record can be an existing record, or a new record depending upon the comparison. For instance, where the comparison indicates a high degree of similarity (e.g., greater than 60% or 70% similar), the context-based data processing tool workflow can automatically save the captured content data into the corresponding, existing similar context-classified record of the data store. If no similar record exists, then a new context-classified record can be created within the data store for containing the captured content data. Note in this regard that an existing application program interface (API) of a data store can be used to interface to the data store and, in one or more embodiments, obtain a listing of existing pages or records within the data store and the respective context metadata for those pages or records. With saving of the captured content data to the data store, the context-based data processing tool workflow can continue by waiting for another capture prompt to repeat the process for another content data capture.

By way of further detail, and as noted, captured content data can be integrated into, for instance, a context-based data store via pseudocode such as set forth below. In this pseudocode, existing page titles are stored in a list existing_titles. The captured content data, referred to as a “catchy line” that is to have its metadata compared, is stored in a variable “catchy_line”. The “compare_titles” function compares the catchy line with each existing page titles using the difflib.SequenceMatcher to calculate the similarity ratio. If a match is found (e.g., similarity ratio≥0.6, in this example), the content data (e.g., line) is saved to the matching page. Otherwise, a new page is created in the data store and the line is saved in the new page.

```
# Existing page titles
  existing_titles = [“Page 1”, “Page 2”, “Page 3”]
  # Catchy line to compare
  catchy_line = “Catchy line to compare”
  # Function to compare catchy line with existing page titles
  def compare_titles(catchy_line, existing_titles):
    match_ratio = 0
    matching_title = None
    for title in existing_titles:
      similarity_ratio = difflib.SequenceMatcher(None, catchy_line,
      title).ratio( )
      if similarity_ratio > match_ratio:
        match_ratio = similarity_ratio
        matching_title = title
    if match_ratio >= 0.6: # Adjust the threshold as needed
      print(f“Match found with title: {matching_title}”)
      # Save the catchy line to the matching page
      # Add your code to save the line to the matching page
    else:
      new_page_title = f“New Page {len(existing_titles) + 1}”
      print(f“No match found. Creating a new page with title:
      {new_page_title}”)
      existing_titles.append(new_page_title)
      # Save the line to the new page
      # Add your code to create a new page and save the line
  # Call the function to compare the catchy line with existing page titles
  compare_titles(catchy_line, existing_titles)
```

By way of specific example, in one or more embodiments, executing context-based data processing tool can perform a multiple step method which includes, for instance, determining the source of the electronic media, such as determining whether the media includes internet posted media, podcast media, downloaded media, etc. In a further step, a capture prompt is used to mark the point of a pause in the processing of the electronic media and a rollback of one or more paragraphs, or a rollback to the start of the media using, for instance, natural language processing to capture one or more sentences at the time of the prompt, such as via text tokenization. In a next step, processing determines whether the captured content data has meaning, and if so, transverses to one or more authorized applications to further process the captured content data. In one embodiment, the process can prompt a user to open an application, such as a context-based data store application, scan the latest context metadata for the captured content data, apply a text matching algorithm, and further based on one or more comparisons of the matching algorithm, append the captured content data to a particular context-classified record to retain a meaningful sentence and/or summary of the captured content. In the case where captured content does not make sense, then a last paragraph in the datastream can be analyzed, with a video or audio text converter being used, after which the text data of the paragraph can be processed, as noted above with respect to the sentence. If no match exists in evaluating the titles or classifications of the data store application, then a new record can be created and the captured content data with the associated context metadata can be stored in that location. In one or more implementations, deep learning can be applied to one or more of the process steps noted to further enhance the data analysis.

Advantageously, systems and methods to intelligently decide to append captured content data to a particular API integrated application and/or to re-summarize the content data and/or create a text file based thereon is provided in conjunction with cognitive analytics and (generative) artificial intelligence to facilitate evaluating a datastream from an authorized source. The executing tool or system disclosed drives the decision making into the applications exposed, organizing, appending, rearranging, or summarizing captured content data by, for instance, advocating through generative AI based on relevant context metadata. If the content data under study is valid, the executing tool or system can determine based on a role, context, intention, etc., to restructure or form an abstract of the captured content data and append it to form a realistic summary. Advantageously, executing the tool or system can further include, in one or more embodiments, creating digital text data from audio data, video data, and/or audio-visual data under study to decide, based on a user role, interest, etc. to take a summary, or just a phrase or a sentence from the digital text data, and to suggest to store the captured content data to the nearest matching page or record of a context-based data store (e.g., data store application) using a combination of artificial intelligence (e.g., generative artificial intelligence) and natural language processing, such as disclosed herein.

Those skilled in the art will note that, in one or more aspects disclosed herein, processing within a computing environment is improved. As noted, in one or more aspects, capabilities are provided to facilitate data processing in which data accessibility is improved and data store (e.g., memory, storage, and/or a combination of memory/storage) requirements are reduced. Processing within the computing environment is enhanced by improving the capture of selected content data, processing of the captured content data, including, but not limited to, obtaining context metadata and associating the context metadata to the captured content data to, for instance, facilitate storage and/or retrieval of content data to/from a context-based data store. Advantageously, by obtaining and associating context metadata to selectively captured content data, such as to selected unstructured data, processing is streamlined, storage requirements are reduced, and memory access is improved. Further, the context-based data processing tool disclosed herein can facilitate enhancing data security within a computing environment and can be advantageously used in combating deepfake audio and/or video data by associating generated context metadata with the captured content data. Advantageously, the context-based data processing tool disclosed herein also facilitates obtaining logically correct content data in a logically correct sequence and further facilitates the obtaining, storing and retrieval of valid, authenticated content data.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprise” (and any form of comprise, such as “comprises” and “comprising”), “have” (and any form of have, such as “has” and “having”), “include” (and any form of include, such as “includes” and “including”), and “contain” (and any form contain, such as “contains” and “containing”) are open-ended linking verbs. As a result, a method or device that “comprises”, “has”, “includes” or “contains” one or more steps or elements possesses those one or more steps or elements, but is not limited to possessing only those one or more steps or elements. Likewise, a step of a method or an element of a device that “comprises”, “has”, “includes” or “contains” one or more features possesses those one or more features, but is not limited to possessing only those one or more features. Furthermore, a device or structure that is configured in a certain way is configured in at least that way, but may also be configured in ways that are not listed.

The corresponding structures, materials, acts, and equivalents of all means or step plus function elements in the claims below, if any, are intended to include any structure, material, or act for performing the function in combination with other claimed elements as specifically claimed. The description of one or more embodiments has been presented for purposes of illustration and description but is not intended to be exhaustive or limited to in the form disclosed. Many modifications and variations will be apparent to those of ordinary skill in the art. The embodiment was chosen and described in order to best explain various aspects and the practical application, and to enable others of ordinary skill in the art to understand various embodiments with various modifications as are suited to the particular use contemplated.

What is claimed is:

1. A computer-implemented method comprising:
executing a context-based data processing tool to facilitate data processing within a computing environment, wherein executing the context-based data processing tool comprises:
capturing, by at least one processor set, selected content data from an electronic media;
generating, via artificial intelligence, relevant context metadata for the captured content data and associating the generated context metadata with the captured content data; and
integrating, by the at least one processor set, the captured content data into a context-based data store using the generated context metadata, wherein the generated context metadata facilitates processing of the captured content data within the computing environment.

2. The computer-implemented method of claim 1, wherein the electronic media comprises an audio-containing datastream and executing the context-based data processing tool further comprises converting in real time the audio-containing datastream to digital text data, and wherein the capturing comprises capturing the selected content data from the digital text data.

3. The computer-implemented method of claim 2, wherein executing the context-based data processing tool further comprises determining that the audio-containing datastream is a valid audio-containing datastream from an authorized data source.

4. The computer-implemented method of claim 2, wherein executing the context-based data processing tool further comprises detecting occurrence of a defined prompt during the converting in real time of the audio-containing datastream to the digital text data, and wherein the capturing is based on detecting the occurrence of the defined prompt.

5. The computer-implemented method of claim 4, wherein the predefined prompt comprises a predefined input event occurring during the converting in real time of the audio-containing datastream to the digital text data.

6. The computer-implemented method of claim 4, wherein the capturing comprises capturing, during the converting in real time of the audio-containing datastream to the digital text data, a specified portion of the digital text data as the selected content data upon detecting the occurrence of the defined prompt.

7. The computer-implemented method of claim 2, wherein integrating the captured content data into the context-based data store using the generated context metadata includes comparing the generated context metadata to context-classified records in the context-based data store, and saving the captured content data into a context-classified record of the context-based data store based on the comparing of the generated context metadata with the context-classified records.

8. The computer-implemented method of claim 2, wherein the audio-containing datastream comprises a datastream selected from the group consisting of an audio datastream and an audiovisual datastream.

9. The computer-implemented method of claim 1, wherein the generating, via artificial intelligence, of the relevant context metadata for the captured content data includes applying natural language processing to the captured content data to determine a content classification of a plurality of content classifications, the generated context metadata comprising the determined content classification.

10. A computer program product for a computing environment, the computer program product comprising:
a set of one or more computer-readable storage media; and
program instructions, collectively stored in the set of one or more storage media, for causing at least one processor set to perform computer operations comprising:
executing a context-based data processing tool to facilitate data processing within the computing environment, wherein executing the context-based data processing tool comprises:
capturing, by the at least one processor set, selected content data from an electronic media;
generating, via artificial intelligence, relevant context metadata for the captured content data and associating the generated context metadata with the captured content data; and
integrating, by the at least one processor set, the captured content data into a context-based data store using the generated context metadata, wherein the generated context metadata facilitates processing of the captured content data within the computing environment.

11. The computer program product of claim 10, wherein the electronic media comprises an audio-containing datastream and executing the context-based data processing tool further comprises converting in real time the audio-containing datastream to digital text data, and wherein the capturing comprises capturing the selected content data from the digital text data.

12. The computer program product of claim 11, wherein executing the context-based data processing tool further comprises determining that the audio-containing datastream is a valid audio-containing datastream from an authorized data source.

13. The computer program product of claim 11, wherein executing the context-based data processing tool further comprises detecting occurrence of a defined prompt during the converting in real time of the audio-containing datastream to the digital text data, and wherein the capturing is based on detecting the occurrence of the defined prompt.

14. The computer program product of claim 11, wherein the predefined prompt comprises a predefined input event occurring during the converting in real time of the audio-containing datastream to the digital text data, and wherein the capturing comprises capturing, during the converting in real time of the audio-containing datastream to the digital text data, a specified portion of the digital text data as the selected content data upon detecting the occurrence of the defined prompt.

15. The computer program product of claim 11, wherein integrating the captured content data into the context-based data store using the generated context metadata includes comparing the generated context metadata to context-classified records in the context-based data store, and saving the captured content data into a context-classified record of the context-based data store based on the comparing of the generated context metadata with the context-classified records.

16. The computer program product of claim 10, wherein the generating, via artificial intelligence, of the relevant context metadata for the captured content data includes applying natural language processing to the captured content data to determine a content classification of a plurality of content classifications, the generated context metadata comprising the determined content classification.

17. A computer system comprising:
at least one processor set;
a set of one or more computer-readable storage media; and
program instructions, collectively stored in the set of one or more storage media, for causing the at least one processor set to perform computer operations comprising:
executing a context-based data processing tool to facilitate data processing within a computing environment, wherein executing the context-based data processing tool comprises:
capturing, by the at least one processor set, selected content data from an electronic media;
generating, via artificial intelligence, relevant context metadata for the captured content data and associating the generated context metadata with the captured content data; and
integrating, by the at least one processor set, the captured content data into a context-based data store using the generated context metadata, wherein the generated context metadata facilitates processing of the captured content data within the computing environment.

18. The computer system of claim 17, wherein the electronic media comprises an audio-containing datastream and executing the context-based data processing tool further comprises converting in real time the audio-containing datastream to digital text data, and wherein the capturing comprises capturing the selected content data from the digital text data.

19. The computer system of claim 18, wherein executing the context-based data processing tool further comprises detecting occurrence of a defined prompt, and wherein the capturing is based on detecting the occurrence of the defined prompt during the converting in real time of the audio-containing datastream to the digital text data, and the predefined prompt comprises a predefined input event occurring during the converting in real time of the audio-containing datastream to the digital text data.

20. The computer system of claim 18, wherein executing the context-based data processing tool further comprises detecting occurrence of a defined prompt, wherein the capturing is based on detecting the occurrence of the defined prompt during the converting in real time of the audio-containing datastream to the digital text data, and wherein the capturing comprises capturing, during the converting in real time of the audio-containing datastream to the digital text data, a specified portion of the digital text data as the selected content data upon detecting the occurrence of the defined prompt.
